(19) United States
(12) Patent Application Publication
(10) Pub. No.: US 2019/0086118 A1
(43) Pub. Date: Mar. 21, 2019

(54) ELECTRIC WATER HEATER

(71) Applicants: Joan Conde Melgar, Vilatenim (ES); Robert Sabari Del Amo, Girona (ES)

(72) Inventors: Joan Conde Melgar, Vilatenim (ES); Robert Sabari Del Amo, Girona (ES)

(21) Appl. No.: 16/085,732

(22) PCT Filed: Mar. 15, 2017
(86) PCT No.: PCT/IB17/00308

§ 371 Date: Sep. 17, 2018

(30) Foreign Application Priority Data
Mar. 15, 2016 (ES) U201630338

(51) Int. Cl. F24H 1/18; H05B 6/10

(52) U.S. Cl. CPC F24H 1/185; F24H 9/1818; H05B 6/108

(57) ABSTRACT

An electric water heater comprising two autonomous parts which are not in contact with each other: One part being a water tank having a plate of ferromagnetic material at its base, and the other part a magnetic induction module with variable control of power.

To operate the water heater, the induction module is coupled to the base of the water tank; the energy is released by magnetic induction from the induction module to the plate of ferromagnetic material at the base of the water heater, which gets hot, heating the water inside the water tank. The fact that the induction module is physically separated from the water tank means that the electricity cannot be in contact with water at any time, so that the safety of the water heater against electric shock is total.

The design allows several induction modules to be connected in parallel for water heaters requiring larger water tanks. A contactless temperature sensor of the water in the water tank ensures the total separation between water and electricity.

As the induction module features variable control of power, it allows either to limit the supply of electric power to the coil manually, or automatically switch the amount of electric power according to the needs of the user allowing for a great deal of programmability and electricity savings.

### RELATED APPLICATION

The present application claims priority and is a continuation of the utility model SOL: U201630338, titled “Storage Water Heater by Variable Magnetic Induction System”, presented in Mar. 15, 2016 and published in Aug. 4, 2016 under the number ES1155709, which is hereby incorporated by reference in its entirety.

Water heater powered by a magnetic induction system with variable control of power.

### OBJECT OF THE INVENTION

The object of the present invention is a storage water heater, which uses magnetic induction technology by means of a magnetic induction coil, which heats a plate of ferromagnetic material. The part in contact with the water to be heated is the plate and the coil is electrically insulated from said plate, which avoids possible accidents when the water contacts the coil. In addition, due to the variable induction and magnetic induction technology, it is possible to raise the temperature of the water above 70° C. quickly and momentarily, which eliminates the bacteria of legionella.

### BACKGROUND OF THE INVENTION

There are currently a multitude of devices and technologies to obtain hot water by using as an energy source the combustion of liquid or gaseous fuels, electricity or solar energy.

In the case of using electricity as an energy source, there are two technologies that are the most used at present, the first and best known is heating by electric heating elements and the second is by means of air to water heat pumps.

The present invention advocates the use of heating by magnetic induction as compared to heating by electrical heating elements; magnetic induction is more efficient and heats water more quickly.

If magnetic induction is compared to air to water heat pumps, the two technologies have a similar energy efficiency, but the cost of manufacturing and installing an air to water heat pump device is much higher than its magnetic induction equivalent; in addition the heat pump requires the installation in ventilated areas and generates a lot of noise when being operated.

DESCRIPTION OF THE INVENTION

The water heater powered by a magnetic induction system with variable control of power, object of the present invention, is of those comprising a thermal water tank with insulated walls and incorporating a cold-water inlet and a hot water outlet. The lower walls of said water tank are provided with concentric holes; to each of said holes a plate of ferromagnetic material is hermetically coupled, the outer surface of which is intended to be in contact with the water contained within the water tank; A magnetic induction inductor coil is connected to the underside of said plate to heat said plate and which is electrically connected to an electric power source, said magnetic induction coil is entirely covered by an electricity insulator material; The said induction coils are controlled by an electronic inverter type device which regulates the electrical energy supplied to the magnetic induction coil as a function of the temperature of the water contained within the water tank measured by one or more temperature probes arranged inside of said water tank and the outlet temperature of the hot water selected by the user in a temperature selector incorporated in the electronic device. Amongst the advantages of the present invention is worth mentioning:
electricity cost savings compared to heating element systems, with a reduction in consumption of 40%,
the heat supply is more efficient with a larger contact surface,
the temperature control is more effective as it lacks the problem of the heat inertia of the heating elements systems, since the induction only provides the necessary heat avoiding the residual heat of the heating elements,
as the electronic control is inverter, once the water is heated, in order to maintain the temperature, it does not require the system to operate at 100% of its nominal power as it regulates the power supply,
maintains the maximum flow rate allowed by the installation of the house, for example if the pipes of the house allow a flow rate of 25 L/min, the water heater is set to deliver the same,
It allows to choose between low consumption while keeping the heating time or higher consumption while lowering the heating time,
low maintenance due to the lack of active parts in contact with water,
high safety as it lacks active parts in contact with water that may cause short circuits, and
reduce the contracted power required in the house with an annual saving of about 30 € for the 50 L model, in addition to the electricity consumption of 40%.

### BRIEF DESCRIPTION OF THE FIGURES

FIG. 1 shows a perspective view of the main elements of the water heater powered by a magnetic induction system with variable control of power

### PREFERRED REALIZATION

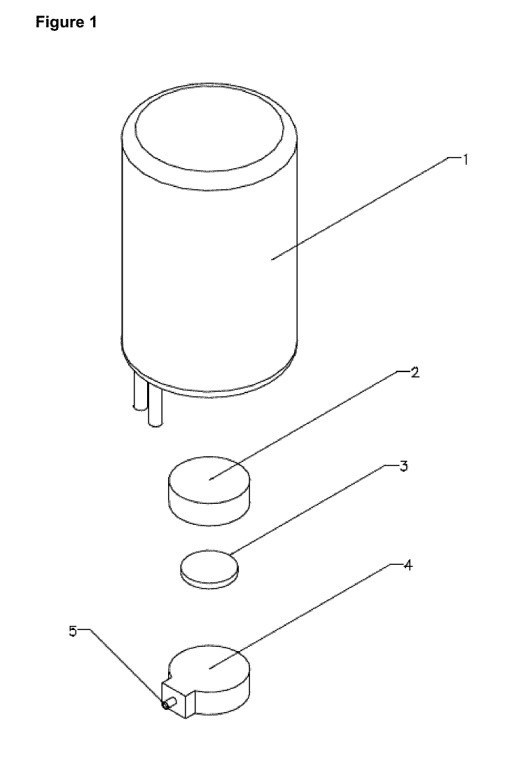

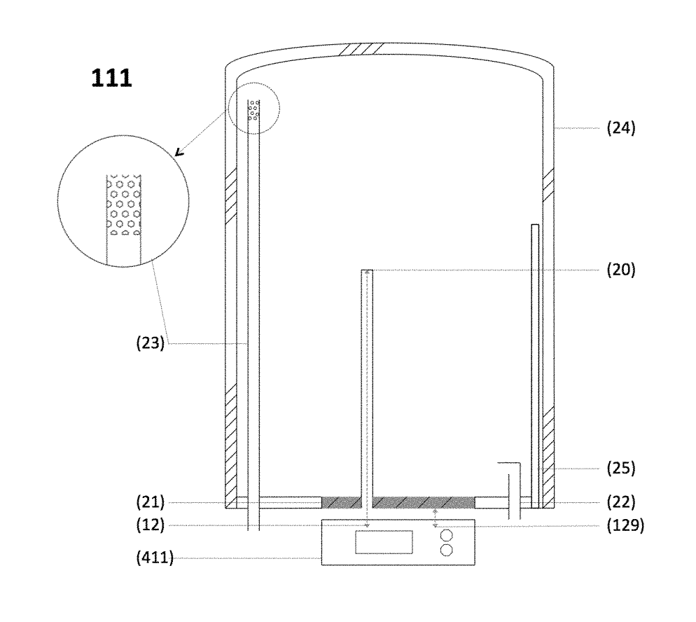

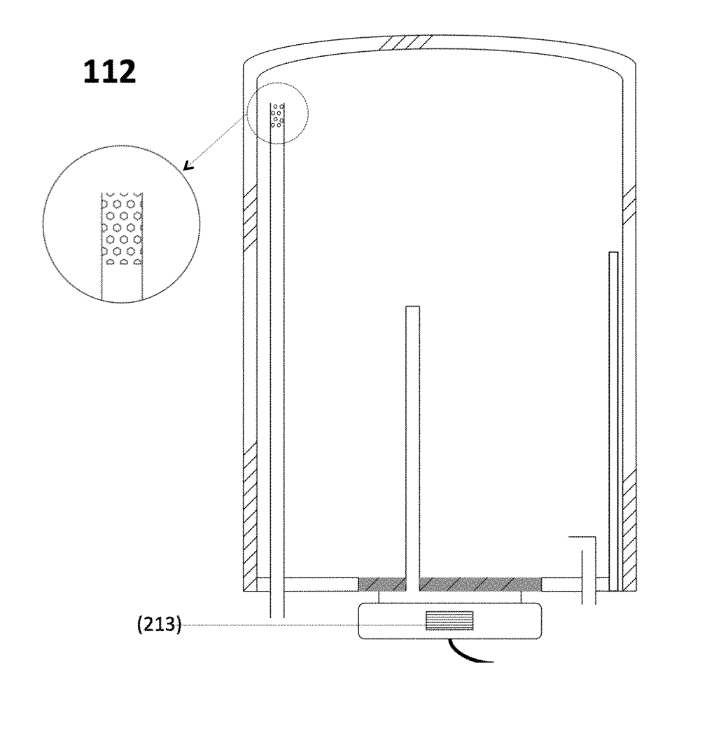

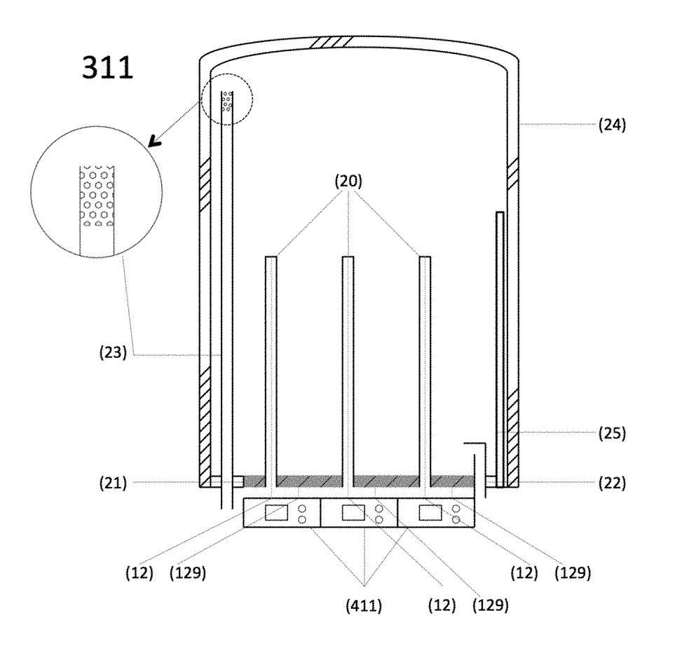

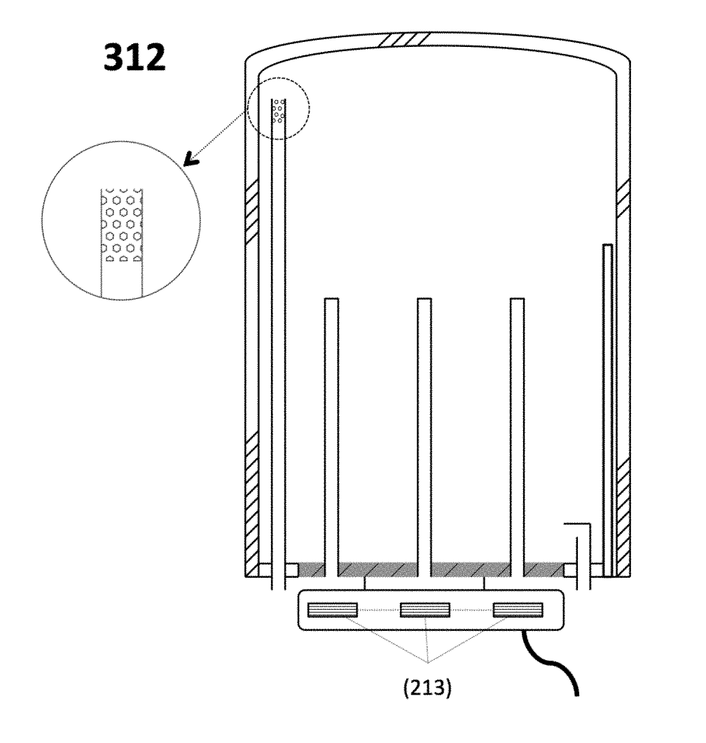

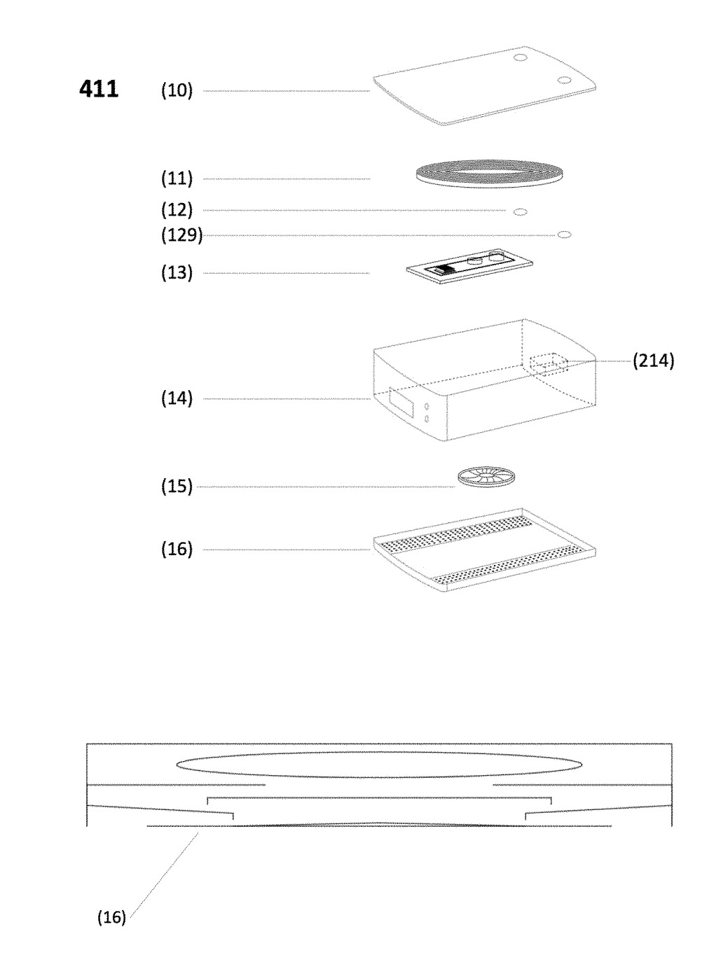

FIG. 1 shows a preferred embodiment of the water heater powered by a magnetic induction system with variable control of power, object of the present invention, which is one of those comprising a thermally insulated double wall water tank (1) incorporating a cold water inlet and a hot water outlet. The lower walls of said water tank are provided with concentric holes; A plate (2) of ferromagnetic material is hermetically coupled to said holes, the outer surface of which is intended to be in contact with the water contained inside the water tank and, if necessary, to heat it; a magnetic induction coil (3) for heating said plate and being electrically connected to a source of electric power is coupled to the lower face of said plate, said magnetic induction coil is wholly coated by an electricity insulator material to avoid possible short circuits produced by contact with water; The said induction coils are controlled by an electronic inverter type device (4) which regulates the electric energy supplied to the magnetic induction coil as a function of the temperature of the water contained in the water tank measured by one or more temperature probes arranged inside said water tank and the outlet temperature of the hot water selected by the user in a temperature selector (5) incorporated in the electronic device. As a design option the magnetic induction coil and the electronic device are coupled forming a module.

### DETAILED DESCRIPTION

Modular Magnetic Induction Water Heater with Variable Control of Power

The present invention improves in almost all aspects and solves many of the problems associated with water heaters based on heating elements. The present invention offers the consumer a safer, more efficient, more programmable, less expensive, cheaper to repair water heater with a higher life expectancy and an expected lower repair time; and provides the manufacturer with a more useful technology at a lower cost, since the cost of the active parts of the water heater, object of the present invention, are much lower than their equivalents in heating elements, which will also be of benefit to the final consumer since, having a lower manufacturing cost, the estimated sale price may expectedly be lower as well. Another advantage of the invention is that, according to the regulations of each country, being the water heater a fully electronic device, it can be considered an appliance and hence any failures that it may have should be covered by the home insurance.

The invention consists of a vertically mounted electric water heater comprising two parts: a water tank of variable capacity, which has no parts in contact with electricity, comprising a plate of ferromagnetic material at its base which is the heat source that heats the water and one or more magnetic induction modules which, when coupled to the water tank base, automatically ignite and begin to heat the ferromagnetic material plate via magnetic induction without any contact with the water tank and consequently without any contact between the electricity and the water tank, providing great safety for the user.

The main features of the induction module are that it is completely watertight with IP45 protection, while it is “Hot Swappable” (i) and “Plug & Play” (ii) and has variable control of power.
(i) Refers to the capability of being able to disconnect and connect devices while another device is on and detect those devices without having to reboot the device.
(ii) Refers to the ability of one device to function next to another as soon as it is connected, without the need for further action.

The variable control of the power, manual and automatic carries a great advantage; it is very programmable and consequently adapts to the needs of the user or manufacturer.

In its basic settings, the water heater can be configured with the following configurations, non exclusive of many others:

Standard Mode: Once the target temperature is reached, the power decreases to a minimum (240 W) to keep the water at a stable temperature and at a minimum cost, avoiding temperature peaks.

Economy Mode: The temperature is maintained constantly at 35° C. (95° F.) and at a specific time set by the user or by pressing “Boost” the temperature increases at maximum power up to 140° F. (60° C.) in 20 minutes in a water heater of 50 Litres (13 gallons) at 3500 W.

User Mode: The user sets the set point for a temperature and adjusts and limits the maximum power of the water heater in cases where the contracted power is low or for example a country house that has no more electricity supply than a 400 W solar panel. In this case the water heater could be configured to only consume 240 W.

Vacation Mode: It is similar to Economy mode but in this case the water heater is kept in Standby, without heating water and without spending energy, and thanks to the remote control by mobile application or computer a signal is sent to the water heater confirming which day and time will be the arrival and so, the water heater is adjusted so that at the arrival time the water temperature is at the set point.

The water heater comprises a water tank vertically mounted, since it improves the stratification of water, of different volumes depending on whether the water heater is mono-modular (only incorporates 1 induction module) or multi-modular (incorporates two or more Induction modules), which means the system ranges from small 30 and 50 litres to large water heaters of 400 litres or more.

The water tank comprises a water inlet and a hot water outlet. The inlet of the hot water outlet pipe comprises several small holes in order to avoid a very common problem, which is the obstruction of the water inlet of the outlet pipe. These small holes in the inlet of the outlet water pipe ensure that the inlet of the pipe will not be obstructed solving a very common problem in most of the water heaters that are currently marketed.

The water tank also comprises one or several pipes in its interior, depending on whether it is a mono-modular or multi-modular water heater, hermetically sealed in the part that is in contact with the water and open at its base, so that the contactless sensor to measure the temperature, laser or infrared, etc. of each induction module can read the temperature of the top of the pipe that is in contact with the water and thus know the temperature of the water inside the water tank without the need to use an electric probe, which needs current to operate and would prevent one of the main advantages of the water heater, object of the present invention, which is the absolute separation of water and electric current for human safety.

The water tank also comprises at its base a plate of ferromagnetic material and at its lowest part means for holding the induction module/s as well as a watertight means for igniting said module/s. The water tank may have at least one sacrificial anode, although the fact of heating the water by heating the plate of ferromagnetic material and not by means of a heating elements, as in conventional electric water heaters, may involve no need to incorporate such sacrificial anode/s as it does not create too much galvanic current (electrolysis).

The induction module is coupled to the base of the water tank, below the ferromagnetic material. Upon insertion, it ignites automatically and immediately initiates the electronic process to heat the water. This induction module consists of a coil, an electronic board, one or more sensors to measure the temperature without contact, which may be an infrared or laser sensor, etc. measuring the temperature of the top of the pipe inside the water tank to know the temperature of the water inside the water tank, another contactless sensor to measure the temperature, being an infrared sensor or a laser sensor etc. pointing to the base of the plate of ferromagnetic material constantly monitoring the temperature of said plate of ferromagnetic material, as a security measure, to avoid excessive temperatures of said plate, a fan and a watertight bottom cover to avoid that any accident by lower or lateral water may come into contact with electricity. This cover has a leakproof design and ensures the sealing of the entire induction module, which achieves an I P45 degree of protection.

The modular design allows multiple modules to be connected in parallel for larger water tanks. Each module acts independently and has the same components, although in certain configurations they can act interdependently. The primary advantage of this modular system is that the water heater will hardly stop functioning because in the event that one induction module fails, the other modules will continue to heat the water. In the case of the mono-modular water heater the advantage is that in the event of failure, as the only active components are in the induction module, which is removable and attachable by the user, replacing said faulty module with another one fixes the problem easily, economically and quickly.

Advantages of the magnetic induction modular water heater with variable control of the power over other current electric water heaters:

More Security

Class 2: No grounding required. More safety as the parts that are in contact with water are not in contact with electricity.

It is legally compatible with situations, which a higher level of security is required such as hospitals, operating rooms, hospitality, etc.

More Efficiency

In laboratory test, we learnt that the water heater, object of the invention, is more efficient than an equivalent water heater of heating elements;

We measured our prototype at 1588 W and a commercially available water heater of 1600 W (two heating elements of 800 W each) sharing the same water tank of 100 L. The results obtained in the Velleman meter show that for the water to reach 65° C. from a temperature of 32° C. at an ambient temperature of 28° C. at maximum power in both systems, the prototype took 33 minutes less than the commercially available water heater, being 24% faster to reach the target temperature while consuming a little less power (—12 W). Our prototype heats water at a ratio of 4.2′/° C., whereas the system based on heating element does so at 5.18′/° C.

More Programability

Having variable control of power allows many possibilities to better adapt to the needs of the user and saving energy. Remote operation via mobile application or computer increases its usability and optimization of energy expenditure.

Lower Manufacturing Cost

Another advantage of the modular magnetic induction water heater, object of the present invention, is that its manufacturing cost is much lower than the cost of an equivalent system based on heating elements. At distributor prices in Europe in 2017, the cost of the active parts of the water heater, object of the invention, compared to an equivalent system based on heating elements is approximately only 29%, implying a savings of 71% in the cost of the active parts.

Fewer Failures

Since there are no active parts in contact with water, the operating temperature is lower and it is made of fewer parts, the durability is expected to be better. Apart from that, according to some studies, magnetism can favour the reduction of incrustations in water pipes, which can also prolong the life span.

Lower Repair Cost

Since it is made of two distinct and separate parts: the water tank and the induction module/s, the latter being the only part having active components. In case of failure, the replacement of the entire induction module should solve the problem in most cases. The induction module is very inexpensive to build and is instantly replaceable by the user.

Lower Downtime for Failure

Since the water tank has no active parts, so that its probability of failing is reduced drastically, and all active parts are in the induction module, in the mono-modular version, replacing the entire induction module can solve the problem in most cases. This, plus the fact that such replacement can be carried out by the user, without the assistance of technical services entails the downtime due to failure can be very short in relation to a water heater of heating elements whose failures are complex and require specialized technical service. In the multi-modular version, the water heater downtime can be reduced completely, due to the operation of the modules that work independently, if one fails, the water heater will continue to work perfectly thanks to the other modules. It will take longer to recover the hot water but will continue to function while the faulty module is replaced.

Home Insurance Coverage

As it is an electronic device, home insurance will cover failures in many countries, which is another advantage for the user.

Sacrifice Anode not Required

As an option of design, the inner layer of the water tank, including the plate of ferromagnetic material, is covered by a thin layer of the same metal; in such a case no sacrificial anodes will be required. Nonetheless, the galvanic electricity measured in our prototype was only 0.50 Vdc, which can be compensated electronically from the induction module.

Ecological Design

It does not generate electrolysis. The same induction module can be used in different water tanks of different sizes, which allows greater savings in the engineering of the water heater. Since it does not need much power to operate, it can be set to use only the minimum power, being useful in cases where the available electrical power is very low or ecological houses whose only source of energy is solar.

Description of the Elements

The modular magnetic induction water heater with variable control of power can be presented in three different ways. The first, its most basic form, forming the induction module part of the water heater as one only unit; it is the case of the drawings 1 to 5. (As explained in “preferred realization”)

A more advanced version is the modular version, which includes two variants: the water heater mono-modular (111 and 112) and the water heater multi-modular (311 and 312). The mono-modular water heater has a single induction module. The drawing (111) shows the water heater with the induction module (411) coupled, and (112) shows the water heater without the induction module (411), showing the power supply means (213) to the induction module. The multi-modular water heater (311 and 312) comprises several induction modules. Drawing 311 and 312 shows three modules, although the modular design allows other configurations such as bi-modular, quad-modular etc. and is suitable for installations where a higher volume of hot water is required and more electric power is available.

The induction module (411) consists of the following elements: top cover (10) made of an insulating material of temperature and electricity, such as Polycarbonate or Methacrylate, at least one coil (11) by means of which the plate of ferromagnetic material (21) at the base of the water tank will be heated, in case of the most advanced configuration, without temperature probes in the water tank, contactless temperature sensors for measuring the temperature, such as infrared or laser sensors etc. (12 and 129). The signal from these sensors passes through the top lid (10) of insulation material of temperature and electricity to measure the temperature at the top of the pipe (20) inside the water tank, said pipe on the outside is in contact with water and hence it's possible to measure the temperature of the water in the water tank without the need of using temperature probes whose operation requires electricity that, although of little intensity, would be in contact with the water in the water tank. The other contactless temperature sensor is the safety sensor (129) and measures the temperature of the ferromagnetic plate (21). The contactless temperature sensors (12 and 129) may be coupled to the electronic board (13), which incorporates the microprocessor and the power inverter. The cover (14) has a power input means (214), which is supplied from the base of the water tank from an insulated plug (213) and separated from the water tank, or autonomously directly to the induction module. The cover (14) also has input means for entering a set point for a temperature of heated water and optionally for entering a set point for a power setting to the induction coil. This is useful in the event that there is a limitation on the contracted power or that the available electrical power is lower for any reason, such as a country house that has no more electricity supply further than this supplied by a 240 W solar panel or only has a low-power electric generator. The design of the module may require the use of a fan (15) and for the bottom cover (16), the invention has a sealed design (16) to prevent any accidents by lateral, lower or upper liquid splashing. The induction module achieves an IP45 degree of protection. The module has means for coupling to the base of the water tank; rails, with or without magnet/s are some of the alternatives, non exclusive of others, to couple the module to the water tank.

The multi-modular version (311 and 312) of the water heater is made by reproduction of the mono-modular structure (111 and 112). As an example, a tri-modular water heater has the same structure as a mono-modular but with three induction modules (411), three times as much as ferromagnetic plate surface (21), and, in its advanced version, without temperature probes in the water tank, three pipes for measuring the temperature inside the water tank.

The main feature of the water tank is that it lacks any active parts in contact with water.

The power supply plug of the module (213), which has a cover of an electrically insulating material, is coupled to the water tank for reasons of convenience and simplicity, although, as an alternative design, it can also be carried out autonomously without having any contact with the tank, the electricity arriving directly at the module without passing through any plugs coupled to the tank, holding the module to the wall, for example, or to any other fixed element involving a fixed and permanent placement in relation to the plate of ferromagnetic material of the water tank. The water heater has a water tank (24), a water inlet (22) and a water outlet pipe (23), characterized in that it has in its inlet many other orifices, limiting a regular problem in conventional water heaters occurring by obstruction of the outlet pipe. The water tank may also carry a sacrificial anode/s (25), although it may not be necessary.

1-2. (canceled)

3. An electric water heater wherein, said water heater comprises:
a) at least one thermally insulated water tank incorporating at least one water inlet and at least one hot water outlet pipe;
b) at least one plate of ferromagnetic material the outer surface of which is intended to be in contact with water contained within the thermally insulated water tank;
c) at least one induction coil situated at a distance from the ferromagnetic material and configured to produce the ferromagnetic material heating through magnetic induction;
d) at least one electronic device;
e) at least one temperature probe configured to measure the temperature of the water inside the water tank;
f) at least one selector to enter a set point for a temperature of the water within the water tank; and
g) a microprocessor, and
h) a module which can be inserted and ejected from the storage water heater, said module comprising at least said induction coil, said electronic device, said microprocessor and said selector;
wherein said microprocessor is configured to receive as input the temperature of water contained in the water tank from the at least one temperature probe and a set point for a temperature of heated water contained in the water tank, and the microprocessor being configured to provide as output a power setting to the induction coil.

4. The water heater of claim 3, further comprising other multiple orifices around the inlet of the said hot water outlet pipe.

5. The water heater of any of the preceding claims, wherein the selector is configured to increase, decrease, limit or interrupt the electrical power supplied to the magnetic induction inductor coil.

6. The water heater of any of the preceding claims, wherein the water heater is remotely operable via a mobile application or computer.

7-8. (canceled)

9. The water heater of claim 3 further comprising in said module an upper cover of temperature and electricity insulating material and a bottom cover which allows ventilation but prevents liquid splashing in the module.

10. The water heater of any preceding claim further comprising a pipe within the water tank hermetically sealed by the parts in contact with the water and open to the outside at its base and at least one contactless temperature probe, such as an infrared or laser sensor, said contactless temperature probe, being coupled inside said module and set to read the temperature of the part of the pipe in contact with the water to detect the temperature of the pipe remotely and hence know the temperature of the water within the said water tank.

11. The water heater according to any preceding claim further comprising a contactless temperature probe, infrared or laser, coupled in said module and set to read the temperature of said plate of ferromagnetic material.

12. The water heater according to any preceding claim wherein the water heater may comprise several of said modules, each operating independently or interdependently of the others.

13. The water heater of any of the preceding claims, wherein the water tank is storage type and is vertically mounted.

14-20. (canceled)

21. The water heater of any of the preceding claims wherein the ferromagnetic material is placed inside the water tank and the induction module is placed outside the water tank.

22. The water heater of any of the preceding claims wherein the induction module is coupled to the base of the water tank, below the ferromagnetic material.
